(19) United States
(12) Patent Application Publication
(10) Pub. No.: US 2024/0166477 A1
(43) Pub. Date: May 23, 2024

(54) OFFSHORE CRANE VESSEL AND METHOD FOR OPERATING THE OFFSHORE CRANE VESSEL

(71) Applicant: Itrec B.V., SCHIEDAM (NL)

(72) Inventors: Joop ROODENBURG, SCHIEDAM (NL); Ronny Lambertus Waltherus NOUWENS, SCHIEDAM (NL)

(73) Assignee: Itrec B.V., SCHIEDAM (NL)

(21) Appl. No.: 18/283,695

(22) PCT Filed: Mar. 18, 2022
(86) PCT No.: PCT/EP2022/057219

§ 371 Date: Sep. 22, 2023

(30) Foreign Application Priority Data
Mar. 25, 2021 (NL) 2027839

(51) Int. Cl. B66C 23/52; B66C 23/66; B66C 23/70; B66C 23/82

(52) U.S. Cl. CPC B66C 23/52; B66C 23/66; B66C 23/702; B66C 23/82

(57) ABSTRACT

In an offshore crane vessel with a crane, for example for use in the handling of one or more offshore wind turbine components, the crane includes a superstructure that is rotatable with respect to a pedestal, and a boom having a length of 60-200 meters. A boom luffing assembly is provided for pivoting the boom about a horizontal boom pivot axis. The crane further includes a main hoisting device for hoisting a load, including a main hoist block assembly supported by a head structure, wherein the head structure is a travelling head structure which is slidable along a part of the boom from the tip end to a second position on the boom.

### FIELD OF THE INVENTION

The invention relates to the field of offshore crane vessels with cranes, for example for use in the handling of one or more offshore wind turbine components, e.g. for installation and/or maintenance of an offshore wind turbine.

### BACKGROUND OF THE INVENTION

In the field of offshore wind turbines, the need exists for the handling very heavy components, like the foundation, e.g. the monopile, which can have a mass of 1000 tons or more. In addition the need exists for the handling of components “at the height of the nacelle”, which includes, for example, the handling of the nacelle itself and/or one or more components that are housed in a nacelle and/or mounted on the nacelle, e.g. a gearbox, an electric generator, the hub, and/or the rotor blades. Current designs propose or already have the nacelle at a height of more than 100 meters above sea level, e.g. at 120 meters or more, for example the Haliade-X 12 MW offshore wind turbine. Therefore, the handling of such components requires a both a very heavy load crane as well as a very tall crane. It is noted that also the mass of the nacelle may be several hundreds of tons, e.g. over 500 tons.

In a common approach, the offshore wind turbine is installed or serviced using a jack-up vessel that is positioned close to the wind turbine location and then the jack-up legs are extended and the vessel is lifted, at least in part but mostly entirely above the sea, to provide a stabilized situation for the crane operation.

It is noted that the invention is primarily envisaged for the field of offshore wind turbines, so for maintenance, and also for installation and/or decommission of wind turbines. However, the inventive crane may also be of use in other offshore applications, like oil & gas related operations, civil engineering operations, etc.

In the field, offshore crane vessels are known comprising a hull, a deck and a crane, the crane comprising:
a pedestal mounted to, or formed integral with, the hull of the vessel;
a superstructure which is rotationally supported by the pedestal for rotation of the superstructure relative to the pedestal about a vertical slew axis, the superstructure comprising a boom connection member;
a boom having a longitudinal axis and a length of 60-200 meters between a pivot end and a tip end; the pivot end being connected to the boom connection member so that the boom is pivotable up and down about a horizontal boom pivot axis; wherein the length of the boom is such that in a horizontal rest position the tip end protrudes outside a perimeter of the hull of the vessel,
a boom rest to support the boom in the horizontal rest position;
a boom luffing assembly for pivoting the boom about the horizontal boom pivot axis, comprising a boom luffing winch and an elongated luffing member extending to the boom;
a main hoisting device for hoisting a load, comprising a main hoisting winch, at least one associated main hoisting cable ( ) and a main hoist block assembly ( ) supported by a head structure.

The handling of one or more offshore wind turbine components, e.g. for installation and/or maintenance of an offshore wind turbine requires a tall crane. That is, the crane will have a long boom so as to have a long reach. A long boom has a length of at least 60 meters, e.g. between 80 and 200 meters. Such a boom protrudes outside a perimeter of the deck of the vessel when the boom is in a horizontally orientation, e.g. in a boom storage position, e.g. during transit.

The volume and weight of the protruding boom and main hoist block assembly has several disadvantages. A known solution is to provide a telescopic boom as disclosed in WO 2020/244973 of same applicant.

### OBJECT OF THE INVENTION

It is an object of a first aspect of the invention to provide an alternative offshore vessel crane.

### SUMMARY OF THE INVENTION

According to the first aspect of the invention the offshore crane vessel is characterised in that the head structure is a travelling head structure which is slidable along a part of the boom from the tip end to a second position on the boom and wherein in the horizontal rest position of the boom and in the second position of the travelling head structure the main hoist block assembly is positioned above the deck of the vessel.

An advantage of the retracted travelling head structure in the second position is that the weight of the travelling head structure and main hoist block assembly is provided above deck, preferably in the vicinity of the boom rest. This prevents fatigue and/or boom bending, in particular during sailing. The retractability allows to select an advantageous distribution of weight on the vessel, by selecting a desired position of the of centre of gravity of main block.

Another advantage of the sliding of the weight is that oscillation of the boom during sailing can be prevented, as the natural frequency of the boom can be tuned.

Another advantage of the main block hoist assembly at the second position, above deck, is the accessibility of the travelling head structure and main block hoist assembly for inspection, maintenance and greasing.

Yet another advantage of the retraction of the travelling head structure and main block hoist assembly is that there is more clearance to the waves during sailing. The boom in the horizontal rest position is usually positioned 20-35 meters above sea level. By removing the volume of the travelling head structure and the main hoist block assembly and possibly a main load suspension device suspended therefrom, this 25-35 meters between sea level and the boom is free space, providing a clearance for waves.

Yet another advantage of the retraction of the travelling head structure and main block hoist assembly is that there is more clearance in harbours. As indicated above, the boom in the horizontal rest position is usually positioned 20-35 meters above sea level, which is commonly no problem above a cay. However, the volume of the main hoist block assembly closer to the waterline is often problematic. By removing the volume of the travelling head structure and the main hoist block assembly, and possibly a main load suspension device suspended therefrom, the space between waterline and boom is free space, providing a clearance for docking the vessel in a harbour.

In a method according to the invention, the offshore crane vessel of the first aspect of the invention is brought to a rest position having the above-indicated advantages. Such a method comprises the steps of:
providing an offshore crane vessel with the travelling head structure fixed at the tip end of the boom,
pivoting the boom by the boom luffing assembly to the horizontal rest position;
supporting the boom on the boom rest;
detaching the travelling head structure from the tip end;
sliding the travelling head structure with the main hoist block assembly along the boom from the tip end to the second position on the boom.

In embodiments, in this rest position the main hoist block assembly is supported in a main hoist block assembly support. Possibly, the travelling head structure is also fixed to the boom at the second position.

The slidable travelling head structure, and a boom allowing the sliding of the travelling head structure therealong can be of a relatively simple construction. The boom needs to be strong enough to support the travelling head structure and allow the sliding thereof. Hence, a reinforced structure may be desired. However, the boom does not need to be hollow as e.g. required for telescopic boom sections. It is envisaged that cords of the boom function as rails for the travelling head structure. In particular when the sliding takes place in a horizontal position of the boom there additional forces on the boom during sliding are limited and do not require major modifications of the boom structure.

The offshore crane vessel of the invention can be a monohull or multihull vessel, a jack-up vessel or even a barge. It comprises a hull with a deck. A pedestal of the crane is mounted to, or formed integral with the hull of the vessel. For a jack-up vessel, it is conceivable that the pedestal is formed around a leg of the jack-up vessel to form a so-called ‘around the leg crane’.

A superstructure is rotationally supported by the pedestal for rotation of the superstructure relative to the pedestal about a vertical slew axis. The superstructure comprises a boom connection member.

A crane boom is provided having a longitudinal axis and a length of 60-200 meters between a pivot end and a tip end. The pivot end is connected to the boom connection member on the superstructure so that the boom is pivotable up and down about a horizontal boom pivot axis. The length of the boom is such that in a horizontal rest position the tip end protrudes outside a perimeter of the hull of the vessel. Possibly, the boom extends significantly outside the perimeter, e.g. more than 5 meters, e.g. more than 10 meters.

The vessel is provided with a boom rest to support the boom in a horizontal rest position, e.g. when the crane is not in use, such as during transit and in harbours. The horizontal rest position is essentially horizontal, and may in practical embodiments deviate 1-15 degrees.

The type of crane of the invention comprises a boom luffing assembly for pivoting the boom about the horizontal boom pivot axis. The boom luffing assembly comprises a boom luffing winch and an elongated luffing member extending to the tip end of the boom. The elongated luffing member comprises a luffing cable extending from the winch and preferably via a luffing cable guide provided at the superstructure.

A main hoisting device is provided for hoisting a load. The main hoisting device comprises a main hoisting winch, at least one associated main hoisting cable, a main hoist block assembly supported by a head structure. The main hoisting cable extends from the main hoisting winch to the main hoist block assembly. The main hoist block assembly comprises a number of sheaves for the hoisting cable. A main load suspension device is preferably suspended from the main block hoist assembly.

According to the present invention the head structure is a travelling head structure which is slidable along a part of the boom from the tip end to a second position on the boom. In the horizontal rest position of the boom and in the second position of the travelling head structure the main hoist block assembly is positioned above the deck of the vessel.

The travelling head structure is e.g. embodied such that it encompasses the boom entirely, as a box. It is also conceivable that the travelling head structure has an U-shape, extending over the bottom part and (part of) the sides of the boom.

In embodiments, a main hoist block assembly support is provided on the deck of the vessel, adapted to support the weight of the main hoist block assembly and possibly also the weight of the travelling head structure. Advantageously, the main hoist block assembly support is provided in line with the pedestal and the boom rest. It is also conceivable that the main hoist block assembly support is formed integral with the boom rest. In the horizontal rest position of the boom and in the second position of the main hoist block assembly the main hoist block assembly is aligned with the main hoist block assembly support. The alignment allows the main hoist block assembly support to, in the rest position of the boom, support the weight of the travelling head structure, and possibly that of the main hoist block assembly.

Advantageously, the main hoist block assembly support allows and simplifies installation and maintenance of the main hoist block assembly, and possibly also alterations of the block and/or cable configuration in the main hoist block assembly.

In embodiments, a head drive is provided to slide the travelling head structure along the boom. Such a head drive e.g. comprising a head winch and a head cable extending between the head winch and the travelling head structure. Such a drive system is e.g. known as a tugger winch and tugger cable. Alternative system, e.g. hydraulic systems or comprising a rack and pinion construction are also conceivable.

In embodiments, the travelling head structure is detachably fixable to the boom at the tip end of the boom and preferably also at the second position of the travelling head structure. This allows the travelling head structure to be fixed to the boom at the tip end thereof during hoisting operations, and detached to allow sliding thereof. Possibly a fastening mechanism is applied that can travel with the travelling head structure to the second position, to fix the travelling head structure to the boom at the second position.

In embodiments, a jib with an auxiliary hoist block is connected to the travelling head structure and slidable with the travelling head structure along the boom. Such an auxiliary hoist block is often present, and thus also protrudes outside the perimeter of the hull of the vessel. The retraction of this jib and auxiliary hoist block, together with the head structure, to a proximal position attributes to the above-indicated advantages of the invention, including an increased clearance and improved weight distribution. It is envisaged that the jib is configured as disclosed in WO2020225157.

In embodiments, the main hoist block assembly is pivotably supported by the travelling head structure about a horizontal pivot structure. This may be advantageous during hoisting operations. In addition, this may be advantageous when the main hoist block assembly in the second position of the travelling head structure. When pivoted to a horizontal position the distance to the deck may be increased in embodiments, thereby attributing to a clear deck space.

In embodiments, the second position on the boom is at a distance from the pivot end of 50-90% of the length of the boom. Most important is that in the second position of the travelling head structure the main hoist block assembly is positioned above the deck of the vessel. However, further weight-related advantages are achieved when the second position more remote from the pivot end. As elucidated later on, further advantages relating to the luffing of the boom are also conceivable, wherein the second position is more proximal than necessary to be above deck.

In embodiments, the boom is embodied as a hollow box structure, preferably a latticed hollow box structure. A possible advantageous configuration of the same applicant is disclosed in WO 2018/208158. It is known to provide a boom having a single leg embodied as a latticed hollow box structure. A known alternative is a A-frame booms which has generally the shape of an A with two boom legs connected, each embodied as a latticed hollow box structure.

Another known example, is a twin leg boom with two parallel legs, each embodied as a latticed hollow box structure, wherein the legs are interconnected by multiple cross members, distributed over the length thereof, interconnecting the boom legs.

In embodiments, a boom portion between the second position of the travelling head structure and the tip end is detachable and can preferably be parked on deck of the vessel. Preferably this is an end portion of the boom. When detaching this end portion from the boom, it is possible that in the horizontal rest position the boom no longer protrudes outside the perimeter of the hull of the vessel.

According to the invention, a boom luffing assembly is provided for pivoting the boom about the horizontal boom pivot axis. The boom luffing assembly comprises a boom winch and an elongated luffing member extending to the boom. The boom luffing assembly advantageously also comprises a luffing cable extending from the boom luffing winch.

Many of the above-indicated advantages are achieved with the elongated boom luffing member extending to the tip end of the boom.

In advantageous embodiments, the elongated luffing member can also engage the boom at a second luffing position opposite the main hoist block assembly at the second position of the travelling head structure. This allows a transfer of the load of the travelling head structure with the main hoist block assembly to the boom luffing assembly. Such a configuration with the luffing member opposite the travelling head structure is advantageous for luffing the boom out of its essentially horizontal rest position. In particular with very long booms with a heavy travelling head structure and main hoist block assembly at a tip end thereof, luffing causes high bucking loads on the boom. Hence, it is advantageous to be able to luff the boom out of the rest position while the travelling head structure and main hoist block assembly are at the second proximal position. Once sufficiently luffed, the travelling head structure and main hoist block assembly are slided along the boom to the tip end thereof.

When luffing at the second luffing position opposite the main hoist block assembly at the second position of the travelling head structure is desired, advantageously the boom is reinforced at this location to allow a transfer of the load of the travelling head structure with the main hoist block assembly to the boom luffing assembly.

In embodiments, the elongated luffing member is connected to the travelling head structure, and is slidable with the travelling head structure along the boom. In such embodiments, the travelling head structure may allow for the transfer of loads. In alternative embodiments, the elongated luffing member comprises an end part fixed to the tip end of the boom, and an auxiliary structure attachable to the boom at a second luffing position opposite the main hoist block assembly at the second position of the travelling head structure. Yet alternatively, an end part of the elongated luffing member is detachable from the boom, and can be attached to the boom at the tip end and at a second luffing position opposite the main hoist block assembly at the second position of the travelling head structure. Optionally, this end part is slidable along the boom.

The travelling head structure has the above-indicated advantages of displacing volume and weight of the head structure and main block hoist assembly.

In addition, the travelling head structure enables inventive methods of operation of such an offshore crane vessel.

In embodiments, the crane can subsequently be brought to an alternative operational position, wherein the method further comprises the steps of:
fixing the travelling head structure to the boom at the second position, and
operating the crane with the travelling head structure at the second position.

Such an operation a.o. involves the pivoting of the boom by the boom luffing assembly away from the horizontal rest position.

In a method according to the invention, the crane is brought to an alternative operational position, wherein the method comprises the steps of:
providing an offshore crane vessel with the travelling head structure fixed at the tip end of the boom,
detaching the travelling head structure from the tip end;
sliding the travelling head structure along the boom from the tip end to the second position on the boom;
fixing the travelling head structure to the boom at the second position, and
operating the crane with the travelling head structure at the second position.

This alternative operational position is in particular advantageous for very long booms, wherein luffing with the elongated luffing member extending to the tip end of the boom is difficult.

In embodiments of the invention the elongated luffing member in the second position of the travelling head structure has slided with the travelling head structure to a position closer to the pivot end of the boom. In alternative embodiments, the elongated luffing member comprises an auxiliary structure attachable to the boom at a second luffing position opposite the second position of the travelling head structure. In both situations, the elongated luffing member engages at a position closer to the pivot end of the boom, which is highly advantageous for upending an elongated boom.

It is conceivable that after initial upending out of the horizontal rest position, the method comprises the following steps:
detaching the travelling head structure from the second position;
sliding the travelling head structure along the boom from the second position to the tip end of the boom;
fixing the travelling head structure to the boom at the tip end, and
operating the crane with the travelling head structure at the tip end.

With the travelling head structure at the tip end further hoisting operations are possible.

In embodiments, the luffing member travels to the tip end with the travelling head structure. In alternative embodiments, the auxiliary structure of the elongated luffing member is detached from the boom at the second luffing position.

In embodiments, it is conceivable that the crane is brought to an alternative operational position with the boom at an upward pivoted, non-horizontal position of the boom, possibly wherein the boom is supported by a boom stop. Hence, the steps of detaching and sliding the travelling head structure are carried out with the boom out of the rest position.

A second aspect of the invention relates to a crane, preferably a crane on an offshore crane vessel, comprising:
a pedestal and a superstructure which is rotationally supported by the pedestal for rotation of the superstructure relative to the pedestal about a vertical slew axis, the superstructure comprising a boom connection member;
a boom having a longitudinal axis and a length of 60-200 meters between a pivot end and a tip end; the pivot end being connected to the boom connection member so that the boom is pivotable up and down about a horizontal boom pivot axis;
a boom rest to support the boom in the horizontal rest position;
a boom luffing assembly for pivoting the boom about the horizontal boom pivot axis, comprising a boom luffing winch and an elongated luffing member extending to the boom;
a main hoisting device for hoisting a load, comprising a main hoisting winch, at least one associated main hoisting cable and a main hoist block assembly supported by a head structure.

A disadvantage of very long booms with a heavy travelling head structure and main hoist block assembly at a tip end thereof is that luffing causes high bucking loads on the boom. In particular when luffing a boom out of its essentially horizontal rest position this is disadvantageous.

It is an aim of the second aspect of the invention to provide an alternative crane.

According to the second aspect of the invention this is achieved in that the head structure is a travelling head structure which is slidable along a part of the boom from the tip end to a second position on the boom, and in that the elongated luffing member can engage the boom at a tip end and at a second luffing position opposite the main hoist block assembly at the second position of the travelling head structure.

This allows a transfer of the load of the travelling head structure with the main hoist block assembly to the boom luffing assembly. Such a configuration with the luffing member opposite the travelling head structure is advantageous for luffing the boom out of its essentially horizontal rest position. In particular with very long booms with a heavy travelling head structure and main hoist block assembly at a tip end thereof, luffing causes high bucking loads on the boom. Hence, it is advantageous to be able to luff the boom out of the rest position while the travelling head structure and main hoist block assembly are at the second proximal position. Once sufficiently luffed, the travelling head structure and main hoist block assembly are slided along the boom to the tip end thereof.

When luffing at the second luffing position opposite the main hoist block assembly at the second position of the travelling head structure is desired, advantageously the boom is reinforced at this location to allow a transfer of the load of the travelling head structure with the main hoist block assembly to the boom luffing assembly.

In embodiments, the elongated luffing member is connected to the travelling head structure, and is slidable with the travelling head structure along the boom. In such embodiments, the travelling head structure may allow for the transfer of loads. In alternative embodiments, the elongated luffing member comprises an end part fixed to the tip end of the boom, and an auxiliary structure attachable to the boom at a second luffing position opposite the main hoist block assembly at the second position of the travelling head structure. Yet alternatively, an end part of the elongated luffing member is detachable from the boom, and can be attached to the boom at the tip end and at a second luffing position opposite the main hoist block assembly at the second position of the travelling head structure. Optionally, this end part is slidable along the boom.

The second aspect of the invention also relates to a method wherein the crane is brought to an alternative operational position, wherein the method comprises the steps of:
providing a crane with the travelling head structure fixed at the tip end of the boom,
detaching the travelling head structure from the tip end;
sliding the travelling head structure along the boom from the tip end to the second position on the boom;
fixing the travelling head structure to the boom at the second position, and
operating the crane with the travelling head structure at the second position.

This alternative operational position is in particular advantageous for very long booms, wherein luffing with the elongated luffing member extending to the tip end of the boom is difficult.

In embodiments of the invention the elongated luffing member in the second position of the travelling head structure has slided with the travelling head structure to a proximal position closer to the pivot end of the boom. In alternative embodiments, the elongated luffing member comprises an auxiliary structure attachable to the boom at a second luffing position opposite the second position of the travelling head structure. In both situations, the elongated luffing member engages at a position closer to the pivot end of the boom, which is highly advantageous for upending an elongated boom.

It is conceivable that after initial upending out of the horizontal rest position, the method comprises the following steps:
detaching the travelling head structure from the second position;
sliding the travelling head structure along the boom from the second position to the tip end of the boom;
fixing the travelling head structure to the boom at the tip end, and
operating the crane with the travelling head structure at the tip end.

With the travelling head structure at the tip end further hoisting operations are possible.

In embodiments, the luffing member travels to the tip end with the travelling head structure. In alternative embodiments, the auxiliary structure of the elongated luffing member is detached from the boom at the second luffing position.

In embodiments, it is conceivable that the crane is brought to an alternative operational position with the boom at an upward pivoted, non-horizontal position of the boom, possibly wherein the boom is supported by a boom stop.

### BRIEF DESCRIPTION OF THE DRAWINGS

The invention will now be described with reference to the figures, in which like reference symbols designate like parts. In these figures:

FIG. 1 shows an offshore crane vessel with a boom protruding outside the perimeter of a hull of the vessel in a horizontal rest position of the boom;

FIG. 2 shows an example of an offshore crane vessel according to the invention with a boom in a horizontal rest position and a head structure in a proximal position;

FIG. 3 shows the vessel of FIG. 2 with the boom in an upwardly pivoted position and the head structure at a tip end of the boom;

FIG. 4 shows the vessel of FIG. 2 with the boom in an upwardly pivoted position and the head structure in the inward position;

FIGS. 5A-5C show steps for a method of operating the offshore crane vessel of FIG. 2;

FIG. 6 shows a travelling head structure being slidable along a part of a boom for an offshore crane vessel according to the invention;

FIG. 7 shows a detail of the travelling head structure of FIG. 6;

FIG. 8 shows a boom for an offshore crane vessel according to the invention, with a head structure being mounted at a tip end of the boom;

FIG. 9 shows a boom for an offshore crane vessel according to the invention, with a head structure being mounted in a second position and with a main hoist block assembly being pivoted upward;

FIG. 10 shows a boom for an offshore crane vessel according to the invention, with a pivotable main hoist block assembly, and with a jib supporting a fixed auxiliary hoist, which jib is connected to a travelling head structure;

FIG. 11 shows a boom for an offshore crane vessel according to the invention, with a jib supporting a fixed auxiliary hoist block, which jib is connected to a travelling head structure;

FIG. 12 shows a main hoist block assembly for an offshore crane vessel according to the invention;

FIGS. 13A-13C show operational positions for an offshore crane vessel according to the invention with a collapsible boom;

FIG. 14 shows an offshore crane vessel according to the invention with a boom in a horizontal rest position and a head structure in a distal position.

### DETAILED DESCRIPTION OF EMBODIMENTS

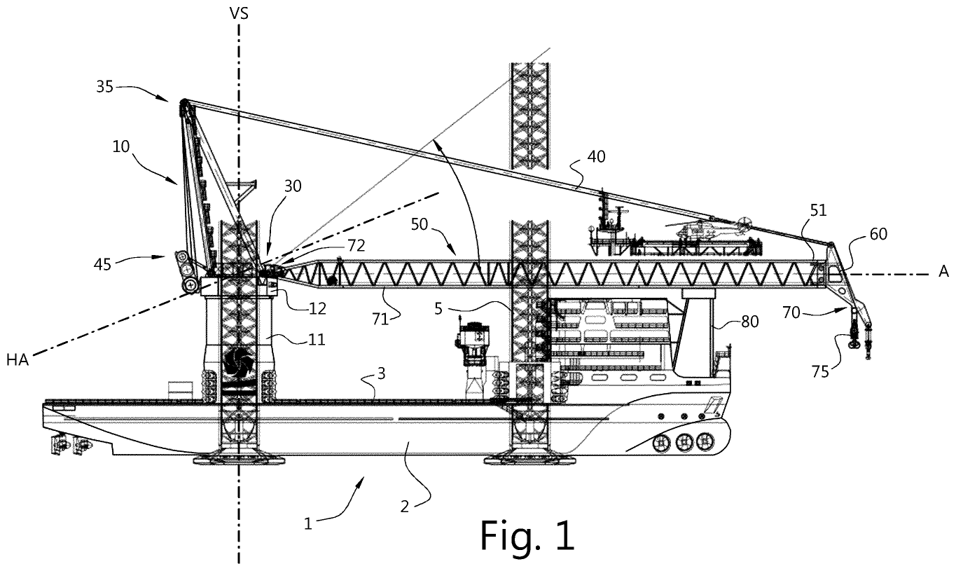

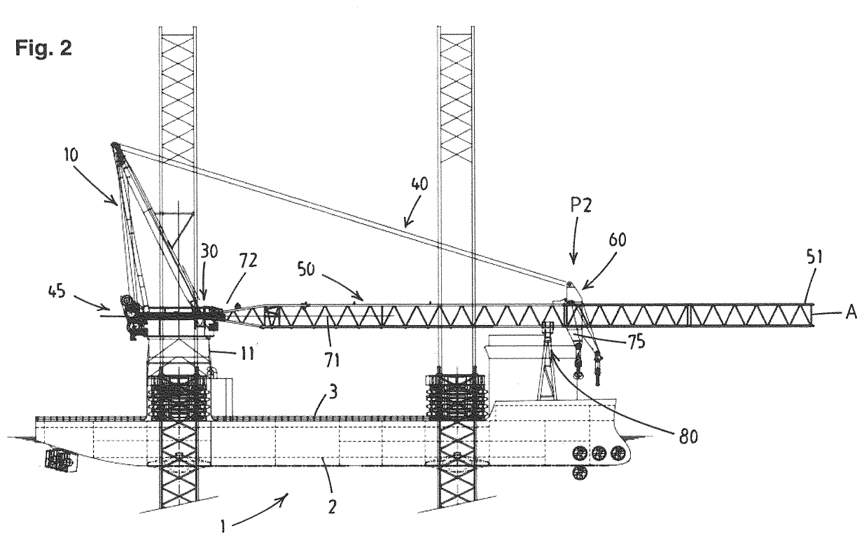

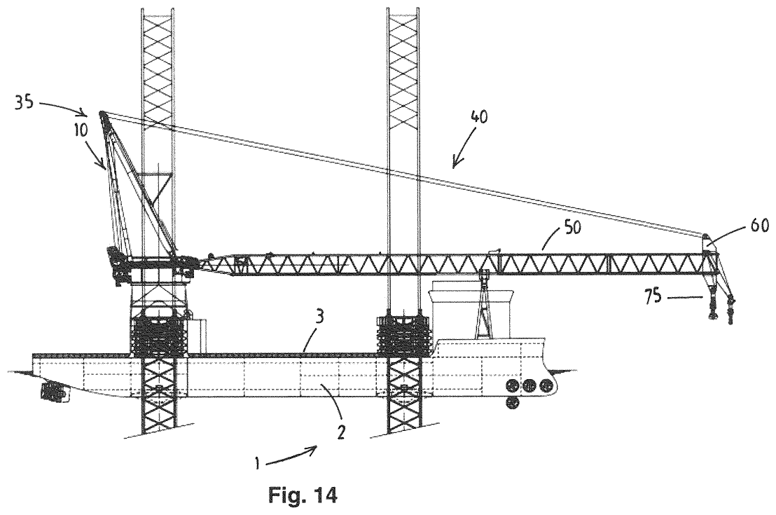

In FIGS. 1, 14 and 2 is shown an offshore crane vessel 1 is shown comprising a hull 2, a deck 3 and a crane 10. The crane 10 comprises a pedestal 11 mounted to, or formed integral with, the hull 2 of the vessel 1. The crane further comprises
a superstructure 12 which is rotationally supported by the pedestal 11 for rotation of the superstructure 12 relative to the pedestal 11 about a vertical slew axis, the superstructure 12 comprising a boom connection member 30;
a boom 50, 50′ having a longitudinal axis A and a length of 60-200 meters between a pivot end 52 and a tip end 51; the pivot end being connected to the boom connection member 30 so that the boom 50 is pivotable up and down about a horizontal boom pivot axis HA; wherein the length of the boom 50 is such that in the horizontal rest position shown in FIGS. 1 and 2 the tip end 51 protrudes significantly outside a perimeter of the hull 2 of the vessel 1,
a boom rest 80 to support the boom 50 in the horizontal rest position;
a boom luffing assembly 35 for pivoting the boom 50 about the horizontal boom pivot axis HA, comprising a boom luffing winch 45 and an elongated luffing member 40 extending to the boom;
a main hoisting device 70 for hoisting a load, comprising a main hoisting winch 72, at least one associated main hoisting cable 71 and a main hoist block assembly 75 supported by a head structure 60, wherein the main hoisting cable 71 extends from the main hoisting winch 72 to the main hoist block assembly 75.

The boom 50 of FIG. 1 protrudes outside the perimeter of the hull 2 of the vessel 1 in the rest position of the boom. The main hoist block assembly 75 is in FIG. 1 positioned at the tip end 51 of the boom 50. As a result, the main hoist block assembly 75 protrudes outside the perimeter of the hull 2 of the vessel 1 in the rest position of the boom 50. The volume and weight of the protruding boom and main hoist block assembly has several disadvantages.

The head structure 60 shown in FIGS. 1 and 2 is a travelling head structure 60 which is slidable along a part of the boom 50 from the tip end 51 to a second position P2 on the boom 50. The head structure 60 can translate from the position shown in FIG. 1, where it is located at the tip end 51, to the position P2 as shown in FIG. 2. There, the boom 50 is also in the horizontal rest position of the boom 50, and in the second position P2 of the travelling head structure 60 the main hoist block assembly 75 is positioned above the deck 3 of the vessel 1.

In FIGS. 1 and 2 a main hoist block assembly 75 hangs freely from the head structure 60, and is thus supported thereby. It can be envisaged that a main hoist block assembly support is provided on the deck of the vessel in line with the pedestal and the boom rest; and wherein in the horizontal rest position of the boom and in the second position of the hoist block assembly the hoist block assembly is aligned with the main hoist block assembly support, such that in the rest position of the boom the weight of the travelling head structure and the main hoist block assembly is supported by the main hoist block assembly support.

The position of the boom 50 in FIG. 1 is in the above called a horizontal rest position, that may e.g. be used during transit. It should be appreciated that the rest position may equally deviate from the horizontal, e.g. with the boom pointing upwards, so long as the boom 50 is supported by the boom rest 80. For the boom rest 80 in FIG. 1 it is noted that it to be located on an outer side of the deck 3 as shown in FIG. 1, or that the location may e.g. be further inboard.

The boom 50 is shown to be embodied as a latticed hollow box structure. It is noted that this is not essential to the invention.

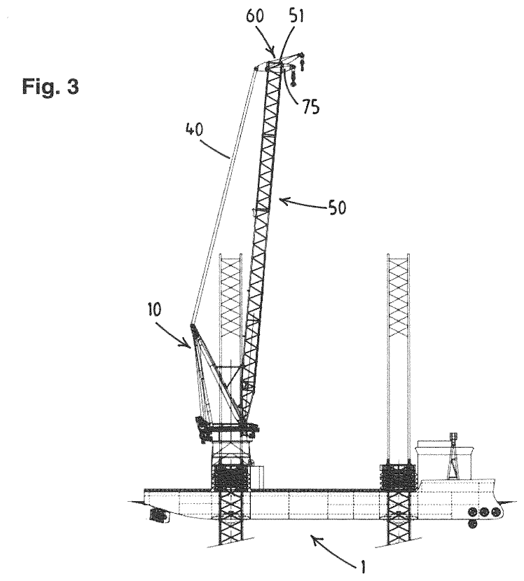

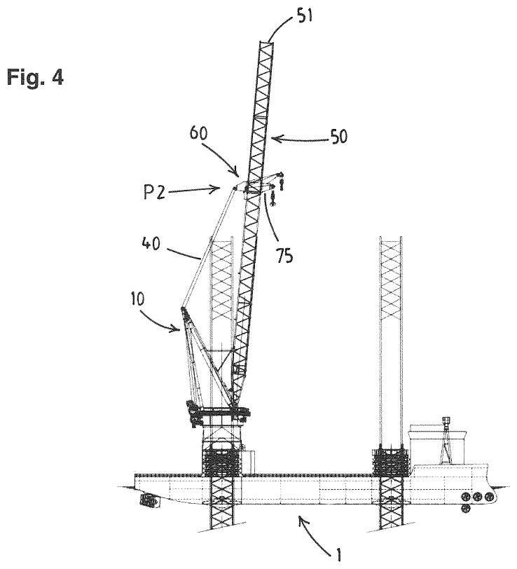

In FIG. 3 is shown the vessel 1 of FIG. 2 with the boom 50 in an upwardly pivoted position and the head structure 60 at a tip end 52 of the boom 50. In FIG. 4 is shown the vessel 1 of FIG. 2 with the boom 50 in an upwardly pivoted position and the head structure in an inward position. That is, the head structure 60 in FIG. 4 is closer to the pivot end 52 of the boom 50 than the head structure 60 of FIG. 3.

In a method according to the invention, the crane 10 is brought to an alternative operational position. This can e.g. be done from the position as shown in FIG. 3 to the position as shown in FIG. 4. This method comprises the steps of:
detaching the travelling head structure 60 from the tip end 51, that is, the fixation of the travelling head structure 60 is detachable;
sliding the travelling head structure 60 with the main hoist block assembly 75 along the boom 50 from the tip end 51 to the second position P2 on the boom 50;
fixing the travelling head structure 60 to the boom 50 at the second position P2, and
operating the crane 10 with the travelling head structure 60 at the second position P2, e.g. as shown in FIG. 4.

Possibly the steps mentioned above are carried out with the boom at an upward pivoted, non-horizontal position of the boom as shown in FIGS. 3 and 4. Possibly the boom 50 is supported by a boom stop.

It can be seen in FIGS. 3 and 4 that the luffing device is connected to the travelling head structure 60 and as such the luffing member 40 travels with the travelling head structure 60. That is, the luffing device is slidable with the travelling head structure 60 along the boom 50. As a result the luffing device adjusts the elongated luffing member 40 accordingly for the second position P2 of FIG. 4. Alternatively the luffing device can be connected to a second luffing position on the boom 50.

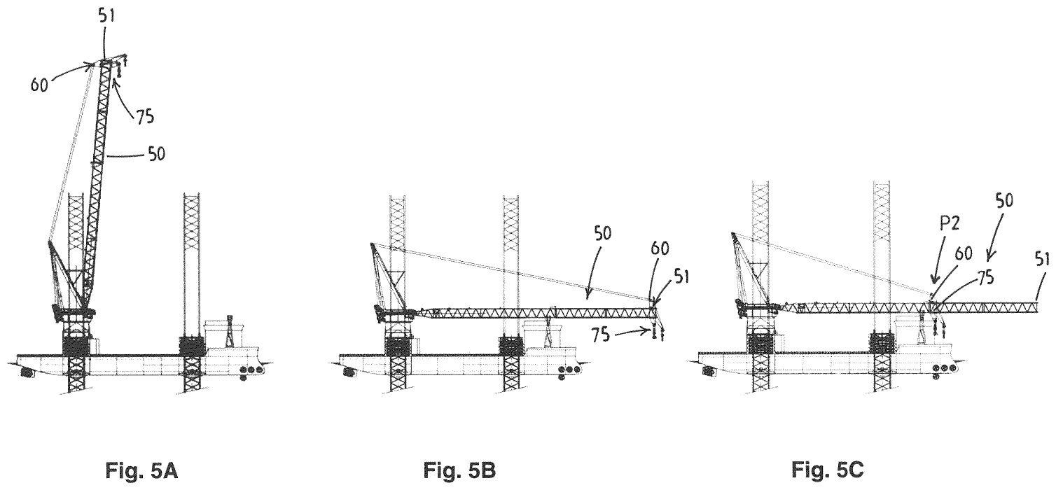

FIGS. 5A-5C show steps for a method of operating the offshore crane vessel of FIG. 2. In this method the crane is brought to a parking position, the method may comprise the steps of:
pivoting the boom 50 by the boom luffing assembly from an upwardly pivoted position as in FIG. 5A to a horizontal rest position as shown in FIG. 5B;
supporting the boom on the boom rest 80;
detaching the travelling head structure 60 from the tip end 51;
sliding the travelling head structure 60 with the main hoist block assembly 75 along the boom 50 from the tip end 51 to the second position P2 on the boom 50;
supporting the main hoist block assembly in a main hoist block assembly support.

Furthermore, the crane can be brought to an alternative operational position. Then the method described above may further comprise the steps of
fixing the travelling head structure 60 to the boom 50 at the second position P2, and
operating the crane with the travelling head structure 60 at the second position P2.

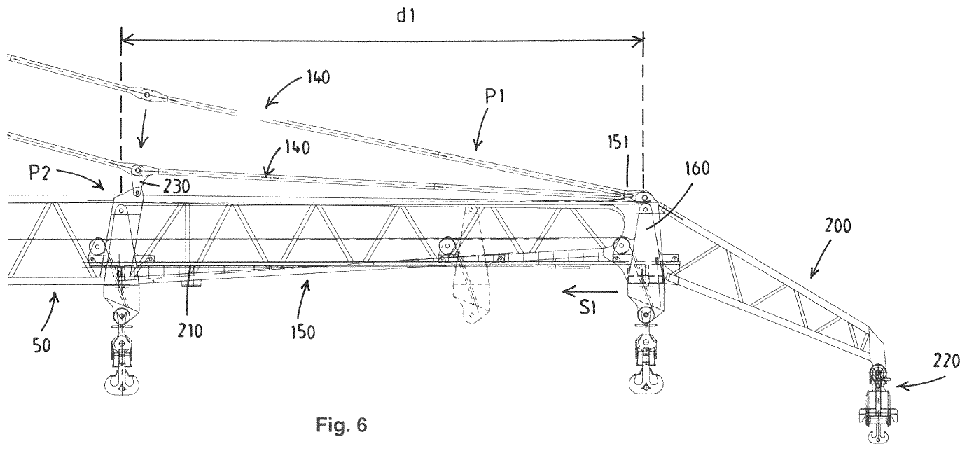

FIG. 6 shows a travelling head structure 160 being slidable along a part of a boom 150 for an offshore crane vessel according to the invention. The boom 150 is a gooseneck boom having a cross-section tapering towards the tip end 151. However, the boom may equally have constant cross-section. A jib 200 supporting an auxiliary hoist block 220 is connected to the boom 150. The boom 150 is provided with rails 210 along which the travelling head structure 160 can slide with a sliding movement S1 as also indicated by the intermediate position P1 of the head structure 160 and the second position P2. To reach P2 the head structure 160 has travelled a distance d1 along a slidable portion of the boom 150. This slidable portion allows for translation of the head structure along the boom. A head drive can be provided to effect this sliding movement S1, so as to slide the travelling head structure 160 along the boom 150.

In FIG. 6 is further shown that the elongated luffing member 140 can be mounted to a strut 230.

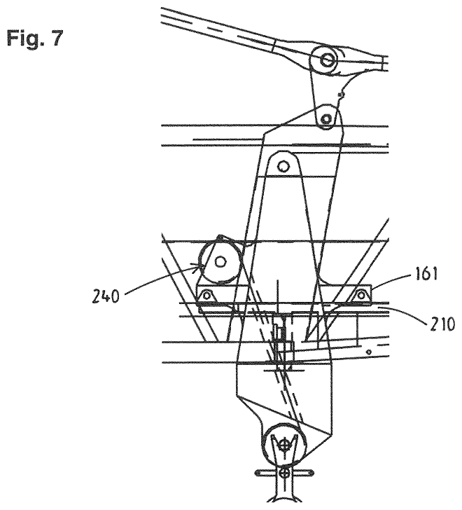

The head structure 160 of FIG. 6 is shown in more detail in FIG. 7. There it can be seen that the head structure 160 comprises sliding members 161, e.g. skid shoes, which can slide along the rail 210. The head structure as shown in FIG. 7 further comprises a sheave 240.

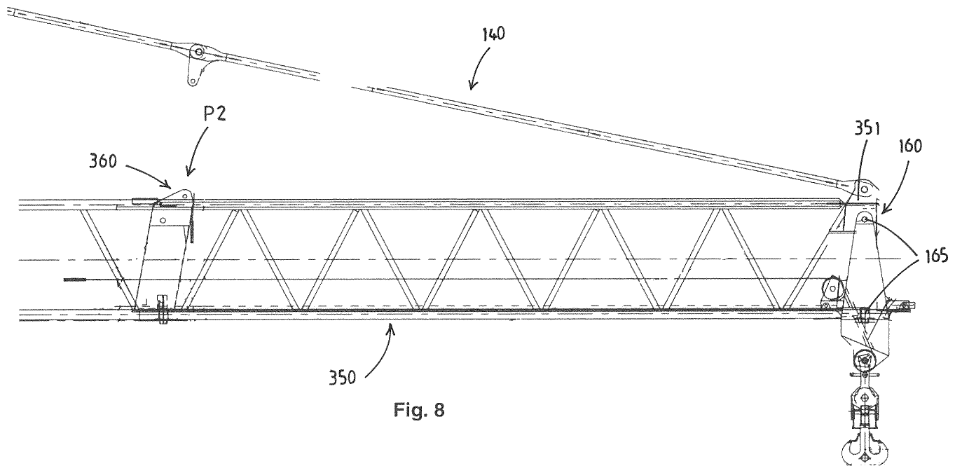

In FIG. 8 is shown a boom 350 for an offshore crane vessel according to the invention, with a head structure 160 located at a tip end 351 of the boom 350. The boom 350 is further provided with a provision 360 at second position P2, e.g. for detachably fixating the head structure 160 to provision 360. The detachable fixation may e.g. be achieved using attachment devices 165, e.g. cylindrical locking pins, that engage the provision 360.

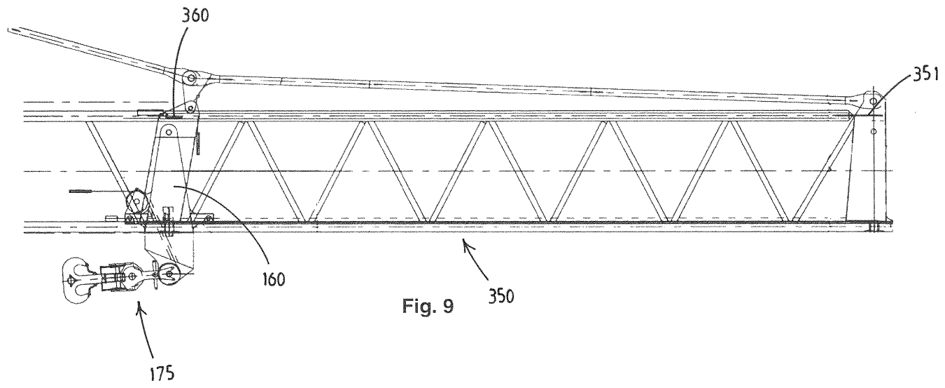

FIG. 9 shows the boom 350 with the head structure 160 in the second position P2, and with the main hoist block assembly 175 being pivoted upward with respect to a hanging position as shown in FIG. 8. That is, the main hoist block assembly 175 is pivotably supported by the travelling head structure 160 about a horizontal pivot structure. In FIG. 9 the main hoist block assembly 175 is pivoted to a horizontal position.

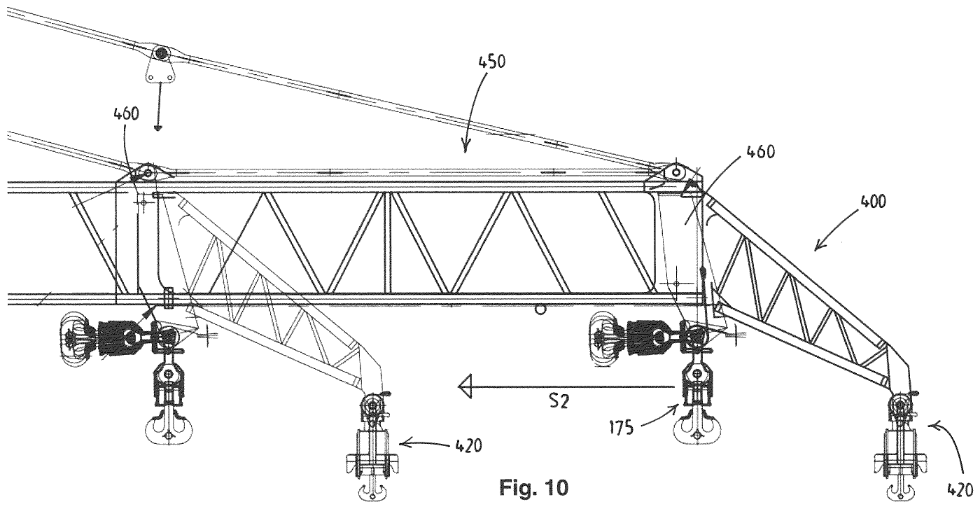

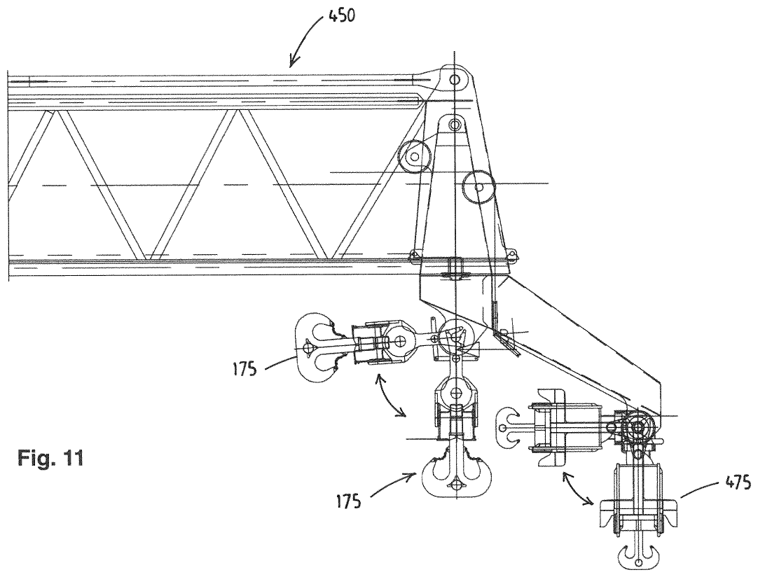

The main hoist block assembly being pivotably supported as described for FIG. 9 is also shown in FIGS. 10 and 11.

In FIG. 10 is shown a boom 450 for an offshore crane vessel according to the invention, with a pivotable main hoist block assembly 175, and with a jib 400 supporting a fixed auxiliary hoist block 420, which jib 400 is connected to a travelling head structure 460. That is, the jib 400 with the auxiliary hoist block 420 is connected to the travelling head structure 460 and slidable therewith along the boom 450, e.g. with the sliding movement S2 shown in FIG. 10.

The auxiliary hoist block can also be pivotable, this is shown in FIG. 11 for auxiliary hoist block 475.

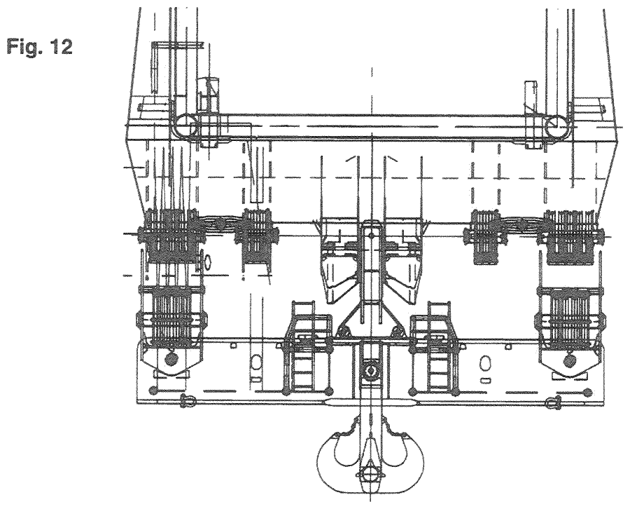

In FIG. 12 details are shown for a main hoist block assembly for an offshore crane vessel according to the invention.

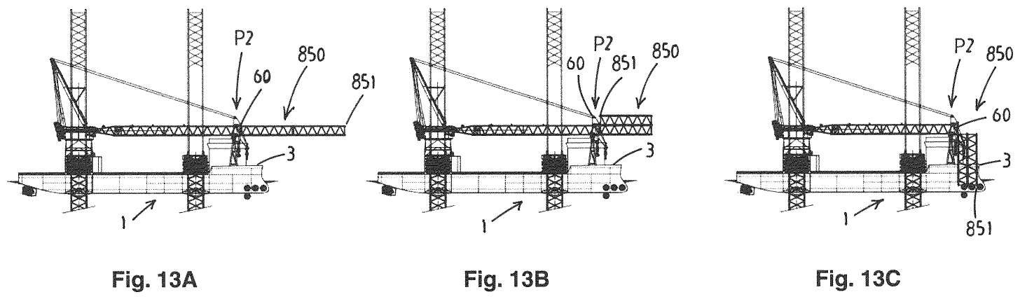

In FIGS. 13A-13C operational positions for an offshore crane vessel according to the invention are shown for a collapsible boom. That is, a boom portion between the second position P2 of the travelling head structure 60 and the tip end 851 is detachable and can preferably be parked on deck 3 of the vessel. As such, in the horizontal rest position of the boom 850 as shown in FIGS. 13A-13C, the boom 850 no longer protrudes outside the perimeter of the vessel 1.

1. An offshore crane vessel with a hull, a deck and a crane, the crane comprising:
a pedestal mounted to, or formed integral with, the hull of the vessel;
a superstructure rotationally supported by the pedestal for rotation of the superstructure relative to the pedestal about a vertical slew axis, the superstructure comprising a boom connection member;
a boom having a longitudinal axis and a length of 60-200 meters between a pivot end and a tip end, the pivot end being connected to the boom connection member so that the boom is pivotable up and down about a horizontal boom pivot axis, wherein the length of the boom is such that in a horizontal rest position the tip end protrudes outside a perimeter of the hull of the vessel;
a boom rest to support the boom in the horizontal rest position;
a boom luffing assembly for pivoting the boom about the horizontal boom pivot axis, comprising a boom luffing winch and an elongated luffing member extending to the boom; and
a main hoisting device for hoisting a load, comprising a main hoisting winch, at least one associated main hoisting cable and a main hoist block assembly supported by a head structure;
wherein the head structure is a travelling head structure, the travelling head structure being slidable along a part of the boom from the tip end to a second position on the boom, and
wherein in the horizontal rest position of the boom and in the second position of the travelling head structure the main hoist block assembly is positioned above the deck of the vessel.

2. The offshore crane vessel of claim 1, wherein a main hoist block assembly support is provided on the deck of the vessel, and
wherein in the horizontal rest position of the boom and in the second position of the main hoist block assembly the main hoist block assembly is aligned with the main hoist block assembly support.

3. The offshore crane vessel according to claim 1, wherein a head drive is provided to slide the travelling head structure along the boom.

4. The offshore crane vessel according to claim 1, wherein the travelling head structure is detachably fixable to the boom at the tip end of the boom.

5. The offshore crane vessel according to claim 1, wherein a jib with an auxiliary hoist block is connected to the travelling head structure and slidable with the travelling head structure along the boom.

6. The offshore crane vessel according to claim 1, wherein the main hoist block assembly is pivotably supported by the travelling head structure about a horizontal pivot structure.

7. The offshore crane vessel according to claim 1, wherein the second position on the boom is at a distance from the pivot end of 50-90% of the length of the boom.

8. The offshore crane vessel according to claim 1, wherein the boom is embodied as a hollow box structure.

9. The offshore crane vessel according to claim 1, wherein a boom portion between the second position of the travelling head structure and the tip end is detachable.

10. The offshore crane vessel according to claim 1, wherein the elongated luffing member is connected to the travelling head structure and is slidable with the travelling head structure along the boom.

11. The offshore crane vessel according to claim 1, wherein the elongated luffing member comprises an end part fixed to the tip end of the boom, and an auxiliary structure attachable to the boom at a second luffing position opposite the main hoist block assembly at the second position of the travelling head structure.

12. A method for operating the offshore crane vessel according to claim 1.

13. The method according to claim 12, the method comprising the steps of:
providing the offshore crane vessel with the travelling head structure fixed at the tip end of the boom;
pivoting the boom by the boom luffing assembly to the horizontal rest position;
supporting the boom on the boom rest;
detaching the travelling head structure from the tip end; and
sliding the travelling head structure along the boom from the tip end to the second position on the boom.

14. The method according to claim 12, wherein the crane is brought to an alternative operational position, the method comprising the steps of:
detaching the travelling head structure from the tip end;
sliding the travelling head structure with the main hoist block assembly along the boom from the tip end to the second position on the boom;
fixing the travelling head structure to the boom at the second position; and
operating the crane with the travelling head structure at the second position.

15. The offshore crane vessel according to claim 1, wherein the travelling head structure is detachably fixable to the boom at the tip end of the boom and at the second position of the travelling head structure.

16. The offshore crane vessel according to claim 1, wherein a boom portion between the second position of the travelling head structure and the tip end is detachable and can be parked on the deck of the vessel.
